(19) United States
(12) Patent Application Publication
(10) Pub. No.: US 2022/0116913 A1
(43) Pub. Date: Apr. 14, 2022

(54) MULTIPLEXING SIDELINK UES WITH DIFFERENT CAPABILITIES

(71) Applicant: QUALCOMM Incorporated, San Diego, CA (US)

(72) Inventors: Seyedkianoush HOSSEINI, San Diego, CA (US); Wei YANG, San Diego, CA (US); Alberto RICO ALVARINO, San Diego, CA (US); Yongjun KWAK, San Diego, CA (US)

(21) Appl. No.: 17/450,280

(22) Filed: Oct. 7, 2021

Related U.S. Application Data
(60) Provisional application No. 63/090,108, filed on Oct. 9, 2020.

(51) Int. Cl. H04W 72/02; H04W 28/26; H04W 72/04; H04W 72/10

(52) U.S. Cl. CPC H04W 72/02; H04W 28/26; H04W 72/10; H04W 72/0406; H04W 72/0453

(57) ABSTRACT

To multiplex wireless devices with different bandwidths, methods, apparatuses, and computer program products are provided. An example method of a wireless device includes reserving one or more sidelink resources for a sidelink transmission, the one or more sidelink resources being associated with one or more subchannels in one or more slots. The example method further includes transmitting a sidelink resource reservation reserving the one or more sidelink resources, the sidelink resource reservation including an indication that the sidelink resource reservation is associated with the reduced bandwidth wireless device.

### CROSS REFERENCE TO RELATED APPLICATION(S)

This application claims the benefit of and priority to U.S. Provisional Application Ser. No. 63/090,108, entitled “MULTIPLEXING SIDELINK UES WITH DIFFERENT CAPABILITIES” and filed on Oct. 9, 2020, which is expressly incorporated by reference herein in its entirety.

### TECHNICAL FIELD

The present disclosure relates generally to communication systems, and more particularly, to sidelink communications with wireless devices that have different bandwidths.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a wireless device are provided. The apparatus may include a memory and at least one processor coupled to the memory. The memory and the at least one processor coupled to the memory may be configured to reserve one or more sidelink resources for a sidelink transmission, the one or more sidelink resources being associated with one or more subchannels in one or more slots. The memory and the at least one processor coupled to the memory may be further configured to transmit a sidelink resource reservation reserving the one or more sidelink resources, the sidelink resource reservation including an indication that the sidelink resource reservation is associated with the reduced bandwidth wireless device.

In another aspect of the disclosure, a method, a computer-readable medium, and an apparatus at a wireless device are provided. The apparatus may include a memory and at least one processor coupled to the memory. The memory and the at least one processor coupled to the memory may be configured to receive a sidelink resource reservation associated with an indication that the sidelink resource reservation is associated with a reduced bandwidth wireless device, the sidelink resource reservation reserving a set of resources for a sidelink transmission from the reduced bandwidth wireless device. The memory and the at least one processor coupled to the memory may be further configured to exclude the set of resources as candidate resources for selection based on the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates an example of wireless communication between devices based on V2X/V2V/D2D communication.

FIG. 5 illustrates example sensing and resource allocation for sidelink transmissions.

FIG. 6 illustrates example resources for sidelink transmissions.

FIG. 7 illustrates example resources for sidelink transmissions.

FIG. 8 is a flowchart of a method of wireless communication.

FIG. 9 is a diagram illustrating an example of a hardware implementation for an example apparatus.

FIG. 10 is a flowchart of a method of wireless communication.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

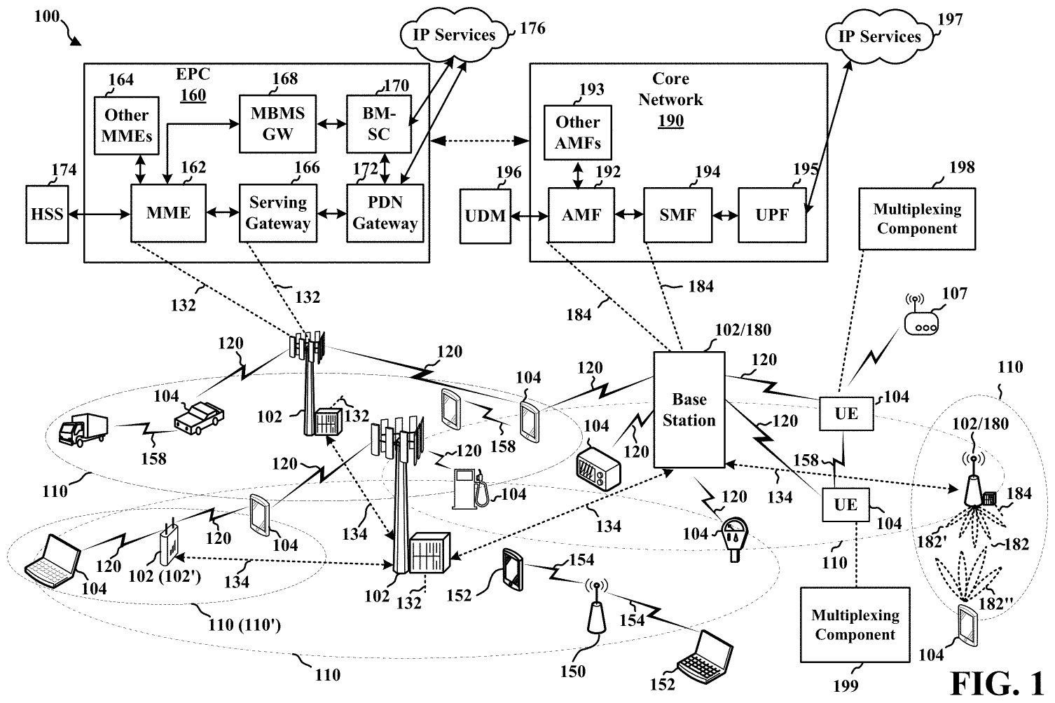

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

A UE 104, Road Side Unit (RSU) 107, or other sidelink devices may include a multiplexing component 198 configured to reserve one or more sidelink resources for a sidelink transmission, the one or more sidelink resources being associated with one or more subchannels in one or more slots; and transmit a sidelink resource reservation reserving the one or more sidelink resources, the sidelink resource reservation including an indication that the sidelink resource reservation is associated with the reduced bandwidth wireless device.

In some aspects, the UE 104, the RSU 107, or other sidelink devices may include a multiplexing component 199 configured to receive a sidelink resource reservation associated with an indication that the sidelink resource reservation is associated with a reduced bandwidth wireless device, the sidelink resource reservation reserving a set of resources for a sidelink transmission from the reduced bandwidth wireless device and exclude the set of resources as candidate resources for selection based on the indication.

Although the following description may be focused on 5G NR, the concepts described herein may be applicable to other similar areas, such as LTE, LTE-A, CDMA, GSM, and other wireless technologies.

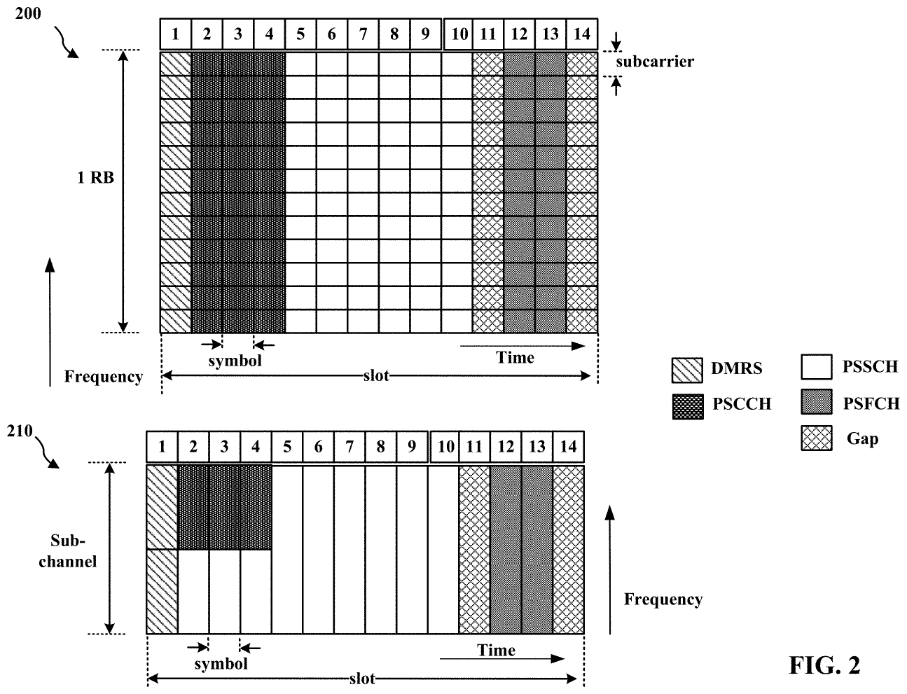

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 2. Multiple slots may be aggregated together in some aspects.

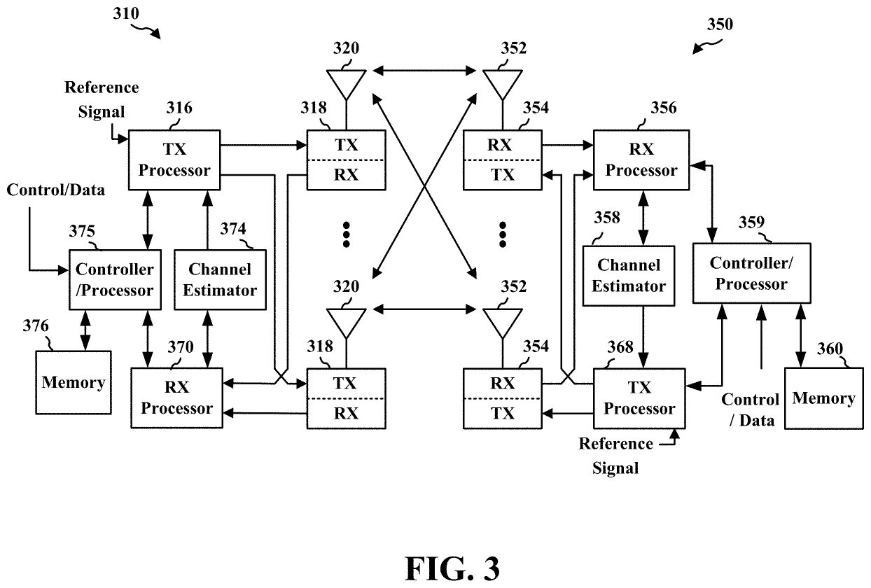

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with multiplexing component 198 of FIG. 1.

At least one of the TX processor 368, the RX processor 356, and the controller/processor 359 may be configured to perform aspects in connection with multiplexing component 199 of FIG. 1.

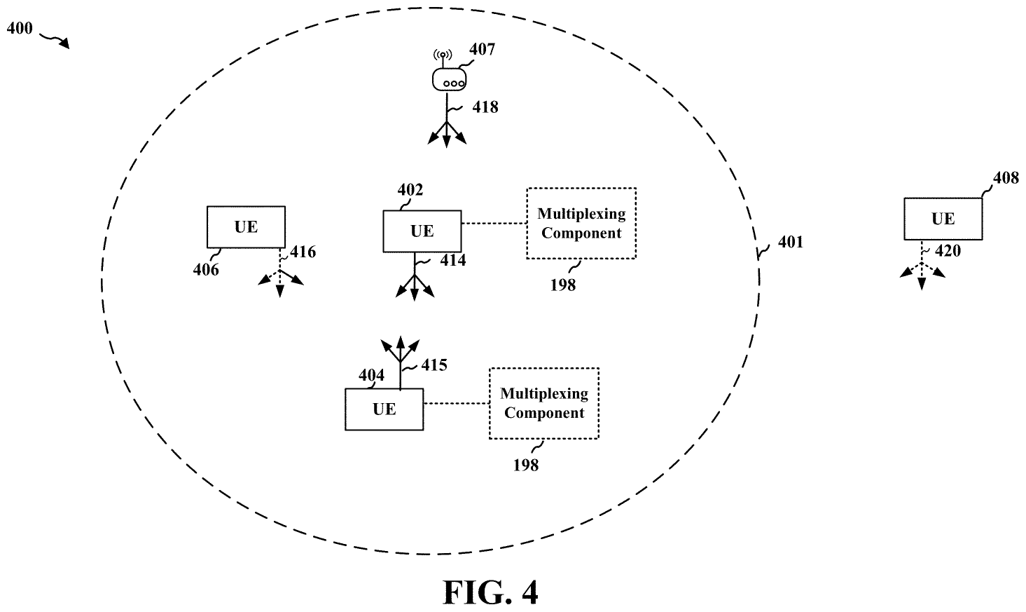

FIG. 4 illustrates an example 400 of wireless communication between devices based on sidelink communication. The communication may be based on a slot structure including aspects described in connection with FIG. 2. For example, UE 402 may transmit a transmission 414, e.g., including a control channel and/or a corresponding data channel, that may be received by UE 404. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The UEs 402, 404, 406, 408 may each be capable of operating as a transmitting device in addition to operating as a receiving device. Thus, UEs 406, 408 are illustrated as transmitting transmissions 416, 420. The transmissions 414, 415, 416, 420 may be broadcast or multicast to nearby devices. For example, UE 402 may transmit communication intended for receipt by other UEs within a range 401 of UE 414. Additionally/alternatively, RSU 407 may receive communication from and/or transmit communication 418 to UEs 402, 404, 406, 408. Some of UEs 402, 404, 406, 408, or RSU 407 may be reduced bandwidth UEs and may include a multiplexing component 198, as described in connection with FIG. 1 that enables the UE to reserve one or more sidelink resources for a sidelink transmission, the one or more sidelink resources being associated with a sidelink frequency resource assignment. The multiplexing component 198 may further enable the UE to transmit a sidelink resource reservation, the sidelink resource reservation including an indication that the sidelink resource reservation is associated with the reduced bandwidth wireless device. Some of UEs 402, 404, 406, 408, or RSU 407 may be non-reduced bandwidth UEs configured to receive a sidelink resource reservation associated with an indication that the sidelink resource reservation is associated with a reduced bandwidth wireless device, the sidelink resource reservation reserving a set of resources. The non-reduced bandwidth UEs may be further configured to refrain from considering the set of resources as candidate resources for selection or may preempt reserved resources after determining that a reduced bandwidth UE has also reserved the same resources.

In addition to higher capability devices wireless communication may support reduced bandwidth devices. Among others, examples of higher capability devices include premium smartphones, V2X devices, URLLC devices, eMBB devices, etc. Among other examples, reduced bandwidth devices may include wearables, industrial wireless sensor networks (IWSN), surveillance cameras, low-end smartphones, etc. For example, NR communication systems may support both full bandwidth devices and reduced bandwidth devices. A reduced bandwidth device may be referred to as an NR light device, a low-tier device, a lower-tier device, etc. Reduced bandwidth UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

As one example, a reduced bandwidth UE may have reduced transmission bandwidth or reception bandwidth compared to other UEs. For instance, a reduced bandwidth UE may have an operating bandwidth between 5 MHz and 20 MHz for both transmission and reception, in contrast to other UEs which may have a bandwidth of up to 100 MHz.

To facilitate scalable and deployable communications, multiple types of reduced bandwidth devices may be introduced. For example, a reduced bandwidth device for URLLC/eMBB may have more stringent specifications on peak throughput, latency, and reliability than a light reduced bandwidth device which may in turn have more stringent specifications than a superlight reduced bandwidth device. On the other hand, a superlight reduced bandwidth device may have improved coverage, complexity, and power consumption compared to a light reduced bandwidth device which may in turn have improved coverage, complexity, and power consumption compared to a reduced bandwidth device for URLLC/eMBB. Some reduced bandwidth devices may support a smaller bandwidth compared with a non-reduced bandwidth device.

In some aspects, superlight reduced bandwidth devices may have better coverage, for example, 20 dB coverage extension, from sidelink relay. In some aspects, low-power sidelink communications may be used for superlight reduced bandwidth devices that are wearable devices or in-home network. Such sidelink communications for superlight reduced bandwidth devices may be power-efficient. For example, sidelink relay may introduce power saving by avoiding a large number of repetitions (up to 2048 repetitions) for coverage extension. In another example, for wearable devices or in-home networks, short-distance sidelink may utilize a reduced power consumption compared to long-distance downlinks or sidelinks. On the other hand, the sidelink communications for V2X may consume a large amount of power in sensing operations.

Sidelink communication may use a set of time/frequency resources defined by a resource pool. A wireless device (e.g., UE) may be configured by higher layers with one or more sidelink resource pools. A sidelink resource pool may be for transmission of a PSSCH or the reception of a PSSCH.

In some wireless communication systems, two resource allocation modes may be supported for sidelink communications. A sidelink resource pool may be associated with either of the two resource allocation modes. Under the first resource allocation mode (resource allocation mode 1), the sidelink resources may be either indicated by a base station dynamically via downlink control information (DCI) format 3_0 or configured. Both Type 1 (configuration based) and Type 2 (activation based) sidelink resource configurations may be supported. Under the second mode (resource allocation mode 2), the UE may select its sidelink transmission resource(s) to be used by the UE for the sidelink transmission(s), e.g., without scheduling from the base station. A UE may determine the sidelink transmission resource(s) based on sensing and resource reservation. In some examples, the mode 2 resource allocation may be referred to as a sensing-based resource allocation for sidelink transmissions.

In the frequency domain, a sidelink resource pool may include a number (numSubchannel) of contiguous sub-channels. A sub-channel may include a number (subchannelsize) of contiguous PRBs. The number of contiguous sub-channels and the number of contiguous PRBs may be higher layer parameters.

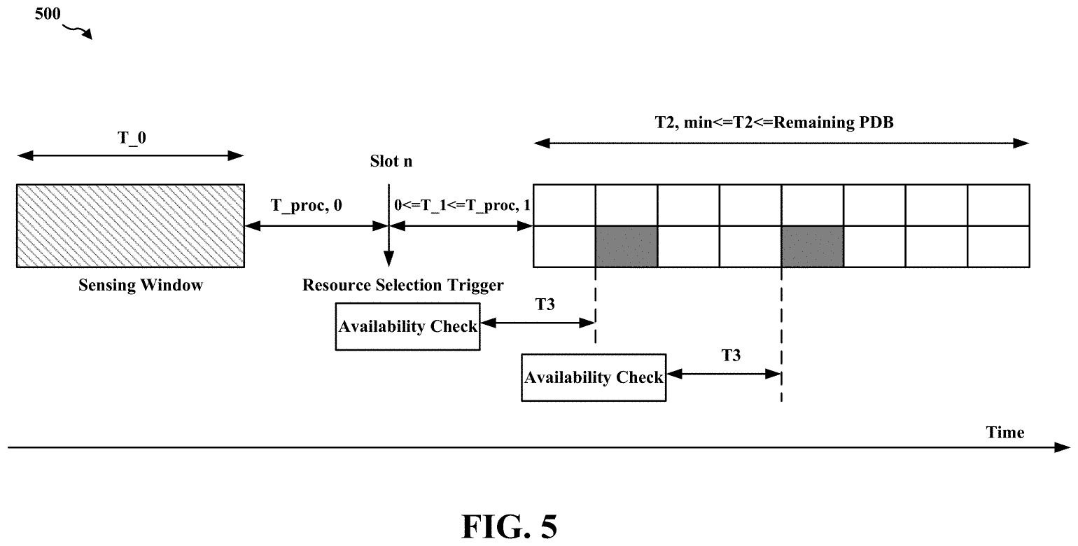

In connection with example 500 in FIG. 5, in the resource allocation mode 2, a higher layer may request the UE 104 that includes the multiplexing component 198 to determine a subset of resources from which the higher layer may select resources for PSSCH/PSCCH transmissions. To trigger resource selection at a slot n, the higher layer may provide a number of parameters including a t2min_SelectionWindow (internal T₂ₘᵢₙ may be set to a corresponding value from higher layer parameter t2min_Selection Window for a given value of prio_{TX} that indicates configured priority {1, 5, 10, 20}·2^{μ} where μ may equal to 0, 1, 2, 3, for subcarrier spacing (SCS) 15, 30, 60, 120 kHz.

If T₂ₘᵢₙ is shorter than a remaining packet delay budget (PDB) (in slots), then T₂ may be determined by the UE 104 and T₂ₘᵢₙ may be less than or equal to T₂ which may be less than or equal to the remaining packet delay budget. If T₂ₘᵢₙ is not shorter than a remaining packet delay budget, resource selection window size T₂ may be set to the remaining packet delay budget. The parameters may further include a t0_SensingWindow where an internal parameter T₀ indicating the sensing window size (T_0 in FIG. 5) that may be the number of slots corresponding to t0_SensingWindow ms. The sensing window may be defined by a range of slots (n−T₀,n−T_{proc,0}^{SL}) where T_{proc,0}^{SL} (T_proc, 0 in FIG. 5) may be defined. The UE may monitor slots which may belong to a sidelink resource pool within the sensing window except for those in which its own transmissions occur. The UE may decode the SCIs received from other UEs in the sensing window. Each UE may attempt to reserve resources in the future that collides with the resource selection window of the UE of interest. Based on a priority of the packet for which another UE is reserving a resource (pj), the priority of the packet of the UE of interest (pi), the configured reference signal received power (RSRP) for the (pi, pj) pair, and the measured RSRP by the UE of interest-based on the reception of PSCCH/PSSCH from the other UE, the UE of interest may determine whether a candidate resource is considered as available or not (i.e., considered as candidate resources for selection).

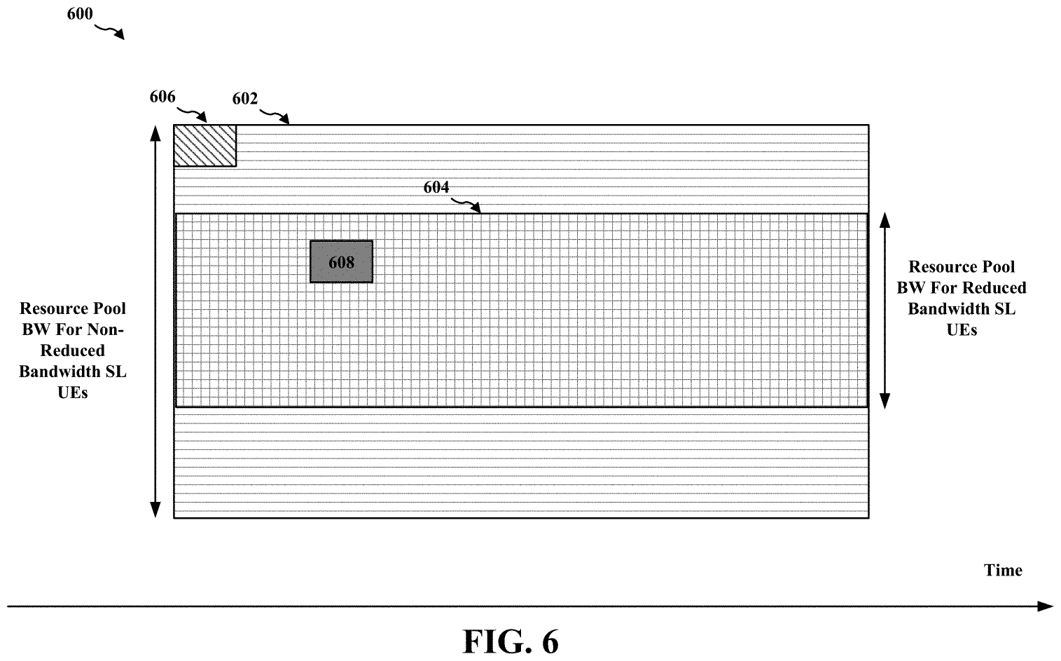

As illustrated in example 600 in FIG. 6, a resource pool 602 for non-reduced bandwidth UEs may be overlapping with (i.e., encompassing) a resource pool 604 for reduced bandwidth UEs. In some aspects, a reduced bandwidth UE may operate in a fraction of the bandwidth of the resource pool 602 or the resource pool 604. When a non-reduced bandwidth UE reserves a set of resources 606 in the portion of a resource pool, the signaling for the reservation 608 may occupy a bandwidth in the resource pool 604 for reduced bandwidth UEs. Because the reservation 608 may be signaled from a portion of the bandwidth that is not included in the operating bandwidth of the reduced bandwidth UEs, the reduced bandwidth UEs may not consider the reservation 608 when performing sensing and reservations. Therefore, a collision (which may be power consuming for the reduced bandwidth UEs) may occur. In addition, reservations made by reduced bandwidth UEs may be detected by non-reduced bandwidth UEs. Aspects presented herein may provide multiplexing mechanisms for reduced bandwidth UEs and non-reduced bandwidth UEs to facilitate more efficient communications. In some aspects, the multiplexing mechanisms may apply to all reduced bandwidth UEs. In some aspects, the multiplexing mechanisms may apply to a subset of reduced bandwidth UEs, such as a superlight UE.

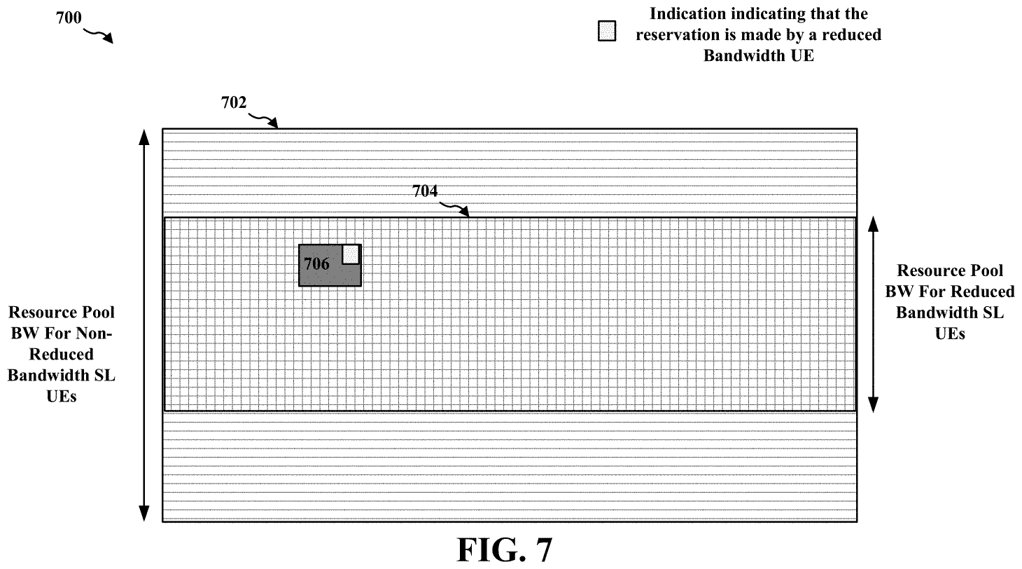

As illustrated in example 700 in FIG. 7, in a communication environment where resource pool 702 for non-reduced bandwidth UEs may surround a resource pool 704 for reduced bandwidth UEs, in some aspects, a sidelink transmission resource reservation 706 from a reduced bandwidth UE may be associated with an indication indicating that the reservation is made by a reduced bandwidth UE. The indication may be included in a PSCCH or SCI, such as SCI2. With the indication, reduced bandwidth UEs may be identifiable by non-reduced bandwidth UEs in the reservation process.

A sidelink frequency resource assignment for the reduced bandwidth UE may be based on the number of subchannels of a resource pool or a portion of the bandwidth of the resource pool. In some aspects, the resource pool 704 configured for reduced bandwidth UEs may not be shared by non-reduced bandwidth UEs. In some aspects, the resource pool 704 configured for reduced bandwidth UEs may be shared by non-reduced bandwidth UEs.

If the resource pool 704 configured for reduced bandwidth UEs is shared by non-reduced bandwidth UEs, the resource reservation for reduced bandwidth UEs and non-reduced bandwidth UEs may be based on the number of subchannels of a larger resource pool (e.g., the resource pool 702) or based on a total bandwidth of the resource pool 702. Therefore, the reduced bandwidth UEs may be aware of the larger resource pool 702 and may have their reservations mapped to the same subchannel grid as understood by the non-reduced bandwidth UEs. In some aspects, for each resource pool configured for a reduced bandwidth UE, additional information may be indicated. The additional information may indicate whether the frequency resource assignment for transmission is based on the number of subchannels of the resource pool configured for the reduced bandwidth UE's transmission/reception (e.g., the resource pool 704) or a different resource pool (e.g., the resource pool 704). In some aspects, if the frequency resource assignment for transmission is based on the number of subchannels of the different resource pool (e.g., the resource pool 704), the starting point for the first subchannel of the resource pool, the size of the subchannels, and the number of subchannels may additionally be indicated. In some aspects, the bandwidth of each reduced bandwidth UE may be one subchannel and such additional information may not need to be included.

In some aspects, each resource pool may be split into a number of non-overlapping subbands. Each subband may include a group of consecutive subchannels. Each reduced bandwidth UE may transmit and receive in a single subband, e.g., the resource pool configured for one reduced bandwidth UE may cover one subband.

In some aspects, if subbands are defined and configured, the reservations made via each SCI sent by a non-reduced bandwidth UE may be within a single subband so that reduced bandwidth UEs active in the same subband can receive the reservations and take them into account when performing resource selection.

In some aspects, reservations are across subbands, or subbands are not defined or configured. In such aspects, regardless of packet priority, a non-reduced bandwidth UE may perform resource re-selection or preemption in favor of the reduced bandwidth UEs after the non-reduced bandwidth UE detects a reservation from a reduced bandwidth UE. For example, if a non-reduced bandwidth UE detects a reservation made by a reduced bandwidth UE, the non-reduced bandwidth UE may not consider the resources indicated in the reservation 706 as potential candidates for selection regardless of its packet priority, the packet priority of the reduced bandwidth UE, or RSRP. In some aspects, to perform resource selection, preemption, or availability check, a high priority (e.g., that may be indicated by a higher numbered or a lower numbered index) may be assigned to the reduced bandwidth UEs regardless of a priority given in the SCI. In some aspects, the priority may be based on a priority offset (pre)configured per UE, per resource pool, per carrier, or per packet. For example, the priority offset may be based on an identifier associated with the UE. As another example, the priority offset may be based on the resource pool. As another example, the priority offset may be based on a carrier priority or packet priority associated with the UE.

In some aspects, a priority threshold may be utilized for the non-reduced bandwidth UEs. If a packet priority for the non-reduced bandwidth UE is below the threshold, the non-reduced bandwidth UE may not consider the resources indicated in a reservation from reduced bandwidth UEs as potential candidates for selection regardless of its packet priority, the packet priority of the reduced bandwidth UE or RSRP. If the packet priority is above the threshold, the non-reduced bandwidth UE may consider the resources indicated in a reservation from reduced bandwidth UEs as potential candidates for selection based on its packet priority, the packet priority of the reduced bandwidth UE, or RSRP.

In some aspects, a separate set of RSRP thresholds for (pi, pj) may be configured, i.e., one RSRP threshold for when the UE attempting to reserve a resource is a non-reduced bandwidth UE and one RSRP threshold for when the UE attempting to reserve a resource is a reduced bandwidth UE, where pi is the packet priority of non-reduced bandwidth UEs and pj is the packet priority of the reduced bandwidth UEs. For example, one RSRP may be for when a non-reduced BW UE is attempting to reserve a resource in the subbands available to reduced BW UEs and another RSRP may be for when it is attempting to reserve a resource outside of such subbands. By way of example, in the former case, the SCI reserving the resource may be sent in a subband available to reduced BW UE and in the latter case, it is not. The separate RSRP thresholds may facilitate that the reservations made by the reduced bandwidth UEs are more protected against the preemption by the non-reduced bandwidth UEs (e.g., a more stringent threshold for the non-reduced bandwidth UEs).

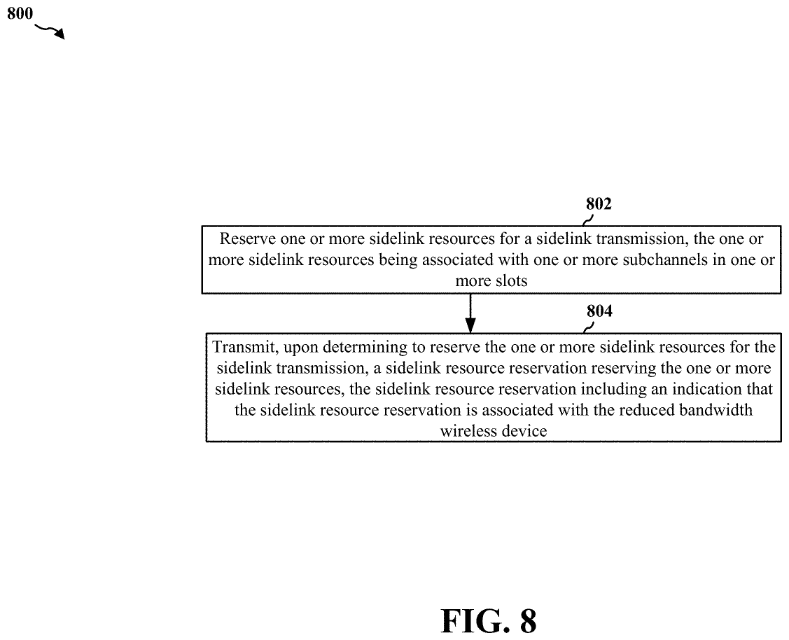

FIG. 8 is a flowchart 800 of a method of wireless communication. The method may be performed by a reduced bandwidth wireless device (e.g., the UE 104, the UE 408, the apparatus 902).

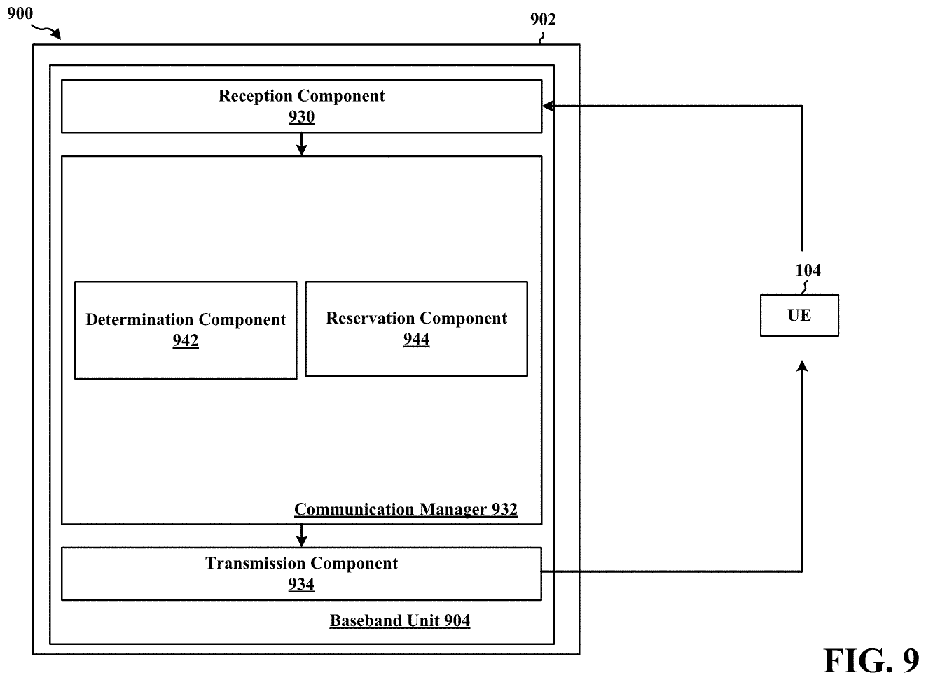

At 802, the wireless device may reserve one or more sidelink resources for a sidelink transmission. The one or more sidelink resources may be associated with one or more subchannels in one or more slots. For example, 802 may be performed by determination component 942 of FIG. 9. In some aspects, the wireless device may reserve one or more sidelink resources for a sidelink transmission based on generating a pending sidelink transmission to be transmitted. If the wireless device has a pending sidelink transmission to be transmitted, the wireless device may reserve the one or more sidelink resources.

At 804, the wireless device may transmit a sidelink resource reservation, the sidelink resource reservation including an indication that the sidelink resource reservation is associated with the reduced bandwidth wireless device. For example, 804 may be performed by reservation component 944 of FIG. 9. In some aspects, the indication may be transmitted via a PSCCH. In some aspects, the indication may be associated with SCI. In some aspects, the sidelink resource reservation may be signaled or broadcasted.

In some aspects, the one or more subchannels in the one or more slots may be associated with a resource pool. In some aspects, the resource pool may be associated with one or more reduced bandwidth wireless devices including the reduced bandwidth wireless device and may be not shared with one or more non-reduced bandwidth wireless devices. In some aspects, the resource pool may be shared with one or more non-reduced bandwidth wireless devices and one or more reduced bandwidth wireless devices including the reduced bandwidth wireless device. In some aspects, the resource pool may be shared with one or more non-reduced bandwidth wireless devices and one or more wireless devices with a reduced bandwidth including the wireless device, and the wireless device may be configured to use a fraction of a bandwidth of the resource pool.

In some aspects, the fraction may be based on the one or more subchannels. In some aspects, the resource pool may be associated with an indication indicating whether the one or more subchannels is based on a sidelink resource pool or a different resource pool. In some aspects, the one or more subchannels may be based on the different resource pool. In some aspects, the indication may further indicate a starting point for a first subchannel of the sidelink resource pool, a size of the subchannels of the sidelink resource pool, and a number of subchannels of the sidelink resource pool. In some aspects, the reduced bandwidth wireless device may be assigned one subchannel as a bandwidth. In some aspects, each resource pool for one or more wireless devices may be split into a number of non-overlapping subbands, each non-overlapping subband may include a group of consecutive subchannels. In some aspects, the reduced bandwidth wireless device may transmit and receive in a single non-overlapping subband of the number of non-overlapping subbands. In some aspects, the non-overlapping subbands may be defined and configured and each SCI from a non-reduced bandwidth wireless device may be within a single non-overlapping subband. In some aspects, the non-overlapping subbands may not be defined and may not be configured.

FIG. 9 is a diagram 900 illustrating an example of a hardware implementation for an apparatus 902. The apparatus 902 is a wireless device and includes a baseband unit 904. The baseband unit 904 may communicate through a cellular RF transceiver with the UE 104. The baseband unit 904 may include a computer-readable medium/memory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the device 310/450 and may include the memory 360/376 and/or at least one of the TX processor 316/368, the RX processor 356/370, and the controller/processor 359/375.

The communication manager 932 includes a determination component 942 that may reserve one or more sidelink resources for a sidelink transmission, the one or more sidelink resources being associated with one or more subchannels in one or more slots, e.g., as described in connection with 802 of FIG. 8. The communication manager 932 further includes a reservation component 944 that may transmit a sidelink resource reservation reserving the one or more sidelink resources, the sidelink resource reservation including an indication that the sidelink resource reservation is associated with the reduced bandwidth wireless device, e.g., as described in connection with 804 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for reserving one or more sidelink resources for a sidelink transmission, the one or more sidelink resources being associated with one or more subchannels in one or more slots. The baseband unit 904 may further include means for transmitting a sidelink resource reservation reserving the one or more sidelink resources, the sidelink resource reservation including an indication that the sidelink resource reservation is associated with the reduced bandwidth wireless device. In some aspects, the baseband unit 904 may further include means for receiving a sidelink frequency resource assignment based on a number of subchannels of a resource pool.

The aforementioned means may be one or more of the aforementioned components of the apparatus 902 configured to perform the functions recited by the aforementioned means. As described supra, the apparatus 902 may include the TX processor 316/368, the RX processor 356/370, and the controller/processor 359/375. As such, in one configuration, the aforementioned means may be the TX processor 316/368, the RX processor 356/370, and the controller/processor 359/375 configured to perform the functions recited by the aforementioned means.

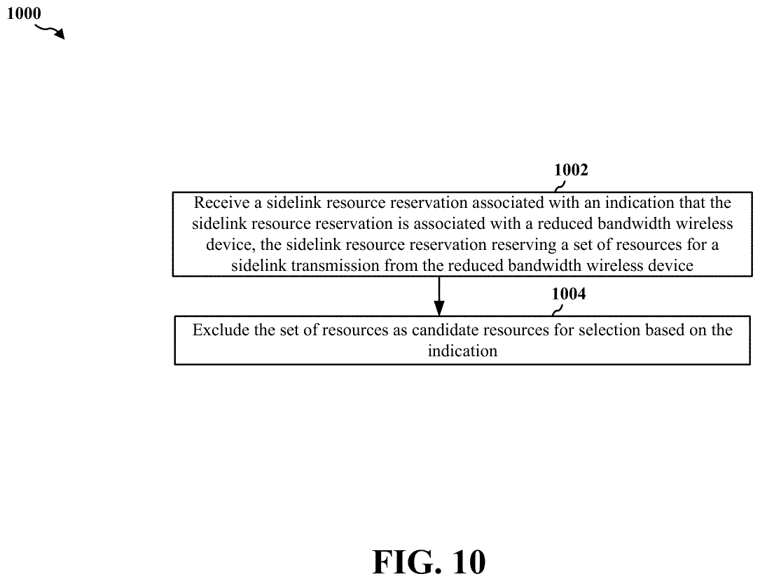

FIG. 10 is a flowchart 1000 of a method of wireless communication. The method may be performed by a non-reduced bandwidth wireless device (e.g., the UE 104, the UE 408, the apparatus 1102).

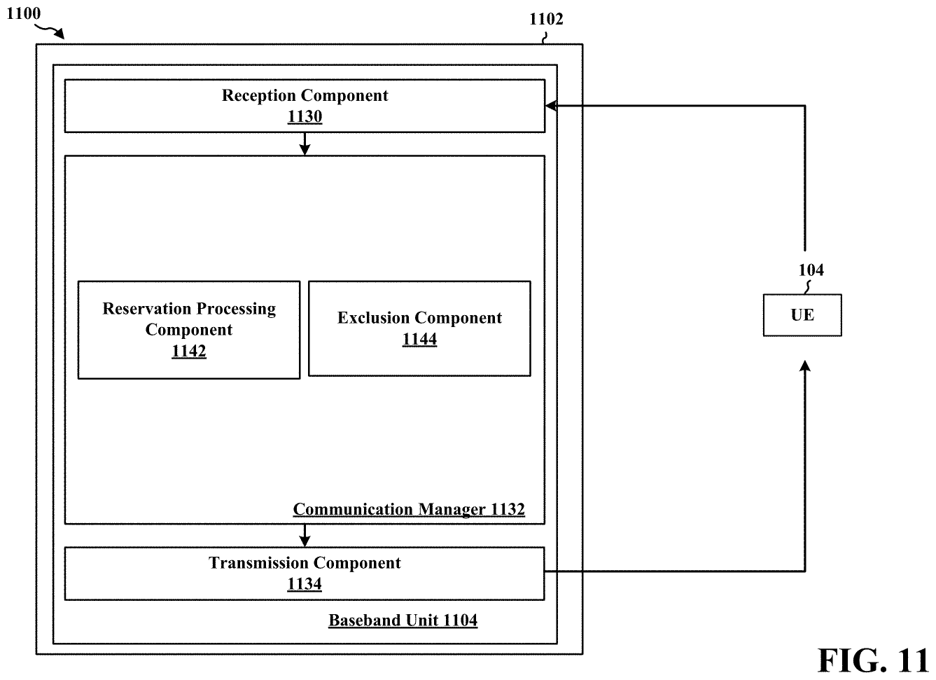

At 1002, the wireless device may receive a sidelink resource reservation associated with an indication that the sidelink resource reservation is associated with a reduced bandwidth wireless device. The sidelink resource reservation may reserve a set of resources for a sidelink transmission from the reduced bandwidth wireless device. For example, a UE may receive a sidelink resource reservation 706 associated with an indication that the sidelink resource reservation is associated with a reduced bandwidth wireless device. For example, 1002 may be performed by reservation processing component 1142 of FIG. 11.

At 1004, the wireless device may exclude the set of resources as candidate resources for selection based on the indication. For example, a UE may exclude resources indicated in the reservation 706 from its candidate resources. In some aspects, the exclusion 1004 may be performed by exclusion component 1144 of FIG. 11. In some aspects, the exclusion may be based on a packet priority for the non-reduced bandwidth wireless device is lower than a packet priority threshold. In some aspects, the exclusion may be independent of a packet priority for the non-reduced bandwidth wireless device. For example, the exclusion may be performed regardless of the packet priority. In some aspects, a priority may be assigned to the sidelink transmission from the reduced bandwidth wireless device. In some aspects, the sidelink transmission from the reduced bandwidth wireless device may be a light or a super light transmission. In some aspects, the priority may be different from a packet priority indicated in SCI of the sidelink transmission. In some aspects, a first RSRP threshold may be configured for the reduced bandwidth wireless device and a second RSRP threshold may be configured for the non-reduced bandwidth wireless device.

FIG. 11 is a diagram 1100 illustrating an example of a hardware implementation for an apparatus 1102. The apparatus 1102 is a wireless device and includes a baseband unit 1104. The baseband unit 1104 may communicate through a cellular RF transceiver with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 804. The baseband unit 1104 may be a component of the device 310/450 and may include the memory 360/376 and/or at least one of the TX processor 316/368, the RX processor 356/370, and the controller/processor 359/375.

The communication manager 1132 includes a reservation processing component 1142 that receives a sidelink resource reservation associated with an indication that the sidelink resource reservation is associated with a reduced bandwidth wireless device, the sidelink resource reservation reserving a set of resources for a sidelink transmission from the reduced bandwidth wireless device, e.g., as described in connection with 1002 of FIG. 10. The communication manager 1132 further includes an exclusion component 1144 that excludes the set of resources as candidate resources for selection based on the indication, e.g., as described in connection with 1004 of FIG. 10.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the baseband unit 1104, includes means for receiving a sidelink resource reservation associated with an indication that the sidelink resource reservation is associated with a reduced bandwidth wireless device, the sidelink resource reservation reserving a set of resources for a sidelink transmission from the reduced bandwidth wireless device. The baseband unit 1104 may further include means for excluding the set of resources as candidate resources for selection based on the indication.

The aforementioned means may be one or more of the aforementioned components of the apparatus 1102 configured to perform the functions recited by the aforementioned means. As described supra, the apparatus 1102 may include the TX processor 316/368, the RX processor 356/370, and the controller/processor 359/375. As such, in one configuration, the aforementioned means may be the TX processor 316/368, the RX processor 356/370, and the controller/processor 359/375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a reduced bandwidth wireless device, comprising: a memory; and at least one processor coupled to the memory and configured to: reserve one or more sidelink resources for a sidelink transmission, the one or more sidelink resources being associated with one or more subchannels in one or more slots; and transmit a sidelink resource reservation reserving the one or more sidelink resources, the sidelink resource reservation including an indication that the sidelink resource reservation is associated with the reduced bandwidth wireless device.

Aspect 2 is the apparatus of aspect 1, wherein to transmit the sidelink resource reservation, the at least one processor coupled to the memory is configured to signal the sidelink resource reservation or broadcast the sidelink resource reservation.

Aspect 3 is the apparatus of any of aspects 1-2, wherein the indication is associated with SCI, and wherein the indication is transmitted via a PSCCH, a first stage SCI, a second stage SCI, or a MAC CE.

Aspect 4 is the apparatus of any of aspects 1-3, wherein the one or more subchannels in the one or more slots is associated with a resource pool.

Aspect 5 is the apparatus of any of aspects 1-4, wherein the resource pool is associated with one or more wireless devices with a reduced bandwidth including the reduced bandwidth wireless device, the resource pool not being shared with one or more non-reduced bandwidth wireless devices.

Aspect 6 is the apparatus of any of aspects 1-4, wherein the resource pool is shared with one or more non-reduced bandwidth wireless devices and one or more wireless devices with a reduced bandwidth including the reduced bandwidth wireless device, and wherein the reduced bandwidth wireless device is configured to use a fraction of a bandwidth of the resource pool.

Aspect 7 is the apparatus of any of aspects 1-4 or 6, wherein the fraction is defined based on the one or more subchannels.

Aspect 8 is the apparatus of any of aspects 1-7, wherein the resource pool is associated with a second indication indicating whether the one or more subchannels is based on a sidelink resource pool or a different resource pool.

Aspect 9 is the apparatus of any of aspects 1-8, wherein the one or more subchannels is based on the different resource pool, and wherein the indication further indicates a starting point for a first subchannel of the sidelink resource pool, a size of subchannels of the sidelink resource pool, and a number of subchannels of the resource pool configured for the sidelink resource pool.

Aspect 10 is the apparatus of any of aspects 6-9, wherein the reduced bandwidth wireless device is assigned one subchannel as the bandwidth.

Aspect 11 is the apparatus of any of aspects 1-10, wherein each resource pool for one or more wireless devices is split into a number of non-overlapping subbands, each non-overlapping subband comprising a group of consecutive subchannels.

Aspect 12 is the apparatus of any of aspects 1-11, wherein the reduced bandwidth wireless device is configured to use a single non-overlapping subband of the number of non-overlapping subbands.

Aspect 13 is the apparatus of any of aspects 1-12, wherein the number of non-overlapping subbands are defined and configured, and wherein each sidelink control information (SCI) from a non-reduced bandwidth wireless device is within one non-overlapping subband of the number of non-overlapping subbands.

Aspect 14 is the apparatus of any of aspects 1-12, wherein the number of non-overlapping subbands are not defined and not configured.

Aspect 15 is the apparatus of any of aspects 1-14, further comprising a transceiver coupled to the at least one processor.

Aspect 16 is an apparatus for wireless communication at a non-reduced bandwidth wireless device, comprising: a memory; and at least one processor coupled to the memory and configured to: receive a sidelink resource reservation associated with an indication that the sidelink resource reservation is associated with a reduced bandwidth wireless device, the sidelink resource reservation reserving a set of resources for a sidelink transmission from the reduced bandwidth wireless device; and exclude the set of resources as candidate resources for selection based on the indication.

Aspect 17 is the apparatus of aspect 16, wherein a priority is assigned to the sidelink transmission from the reduced bandwidth wireless device.

Aspect 18 is the apparatus of any of aspects 16-17, wherein the priority is different from a packet priority indicated in SCI associated with the sidelink transmission.

Aspect 19 is the apparatus of any of aspects 16-18, wherein a first reference signal received power (RSRP) threshold is configured for the reduced bandwidth wireless device and a second RSRP threshold is configured for the reduced bandwidth wireless device.

Aspect 20 is the apparatus of any of aspects 16-19, wherein the indication indicating that the sidelink resource reservation is associated with the reduced bandwidth wireless device is received from the reduced bandwidth wireless device.

Aspect 21 is the apparatus of any of aspects 16-20, wherein the excluded set of resources is based on a packet priority for the wireless device being lower than a packet priority threshold.

Aspect 22 is the apparatus of any of aspects 16-20, wherein the excluded set of resources is independent of a packet priority for the reduced bandwidth wireless device.

Aspect 23 is the apparatus of any of aspects 16-22, further comprising a transceiver coupled to the at least one processor.

Aspect 24 is a method of wireless communication for implementing any of aspects 1 to 15.

Aspect 25 is an apparatus for wireless communication including means for implementing any of aspects 1 to 15.

Aspect 26 is a computer-readable medium storing computer executable code, where the code when executed by a processor causes the processor to implement any of aspects 1 to 15.

Aspect 27 is a method of wireless communication for implementing any of aspects 16 to 24.

Aspect 28 is an apparatus for wireless communication including means for implementing any of aspects 16 to 24.

Aspect 29 is a computer-readable medium storing computer executable code, where the code when executed by a processor causes the processor to implement any of aspects 16 to 24.

What is claimed is:

1. An apparatus for wireless communication at a reduced bandwidth wireless device, comprising:
a memory; and
at least one processor coupled to the memory and configured to:
reserve one or more sidelink resources for a sidelink transmission, the one or more sidelink resources being associated with one or more subchannels in one or more slots; and
transmit a sidelink resource reservation reserving the one or more sidelink resources, the sidelink resource reservation including an indication that the sidelink resource reservation is associated with the reduced bandwidth wireless device.

2. The apparatus of claim 1, wherein to transmit the sidelink resource reservation, the at least one processor coupled to the memory is configured to signal the sidelink resource reservation or broadcast the sidelink resource reservation.

3. The apparatus of claim 1, wherein the indication is associated with sidelink control information (SCI), and wherein the indication is transmitted via a physical sidelink control channel (PSCCH), a first stage SCI, a second stage SCI, or a medium access control (MAC) control element (CE).

4. The apparatus of claim 1, wherein the one or more subchannels in the one or more slots is associated with a resource pool.

5. The apparatus of claim 4, wherein the resource pool is associated with one or more wireless devices with a reduced bandwidth including the reduced bandwidth wireless device, the resource pool not being shared with one or more non-reduced bandwidth wireless devices.

6. The apparatus of claim 4, wherein the resource pool is shared with one or more non-reduced bandwidth wireless devices and one or more wireless devices with a reduced bandwidth including the reduced bandwidth wireless device, and wherein the reduced bandwidth wireless device is configured to use a fraction of a bandwidth of the resource pool.

7. The apparatus of claim 6, wherein the fraction is defined based on the one or more subchannels.

8. The apparatus of claim 6, wherein the resource pool is associated with a second indication indicating whether the one or more subchannels is based on a sidelink resource pool or a different resource pool.

9. The apparatus of claim 8, wherein the one or more subchannels is based on the different resource pool, and wherein the indication further indicates a starting point for a first subchannel of the sidelink resource pool, a size of subchannels of the sidelink resource pool, and a number of subchannels of the resource pool configured for the sidelink resource pool.

10. The apparatus of claim 6, wherein the reduced bandwidth wireless device is assigned one subchannel as the bandwidth.

11. The apparatus of claim 1, wherein each resource pool for one or more wireless devices is split into a number of non-overlapping subbands, each non-overlapping subband comprising a group of consecutive subchannels.

12. The apparatus of claim 11, wherein the reduced bandwidth wireless device is configured to use a single non-overlapping subband of the number of non-overlapping subbands.

13. The apparatus of claim 12, wherein the number of non-overlapping subbands are defined and configured, and wherein each sidelink control information (SCI) from a non-reduced bandwidth wireless device is within one non-overlapping subband of the number of non-overlapping subbands.

14. The apparatus of claim 12, wherein the number of non-overlapping subbands are not defined and not configured.

15. The apparatus of claim 1, further comprising a transceiver coupled to the at least one processor.

16. An apparatus for wireless communication at a non-reduced bandwidth wireless device, comprising:
a memory; and
at least one processor coupled to the memory and configured to:
receive a sidelink resource reservation associated with an indication that the sidelink resource reservation is associated with a reduced bandwidth wireless device, the sidelink resource reservation reserving a set of resources for a sidelink transmission from the reduced bandwidth wireless device; and
exclude the set of resources as candidate resources for selection based on the indication.

17. The apparatus of claim 16, wherein a priority is assigned to the sidelink transmission from the reduced bandwidth wireless device.

18. The apparatus of claim 17, wherein the priority is different from a packet priority indicated in sidelink control information (SCI) associated with the sidelink transmission.

19. The apparatus of claim 16, wherein a first reference signal received power (RSRP) threshold is configured for the reduced bandwidth wireless device and a second RSRP threshold is configured for the reduced bandwidth wireless device.

20. The apparatus of claim 19, wherein the indication indicating that the sidelink resource reservation is associated with the reduced bandwidth wireless device is received from the reduced bandwidth wireless device.

21. The apparatus of claim 16, wherein the excluded set of resources is based on a packet priority for the wireless device being lower than a packet priority threshold.

22. The apparatus of claim 16, wherein the excluded set of resources is independent of a packet priority for the reduced bandwidth wireless device.

23. The apparatus of claim 16, further comprising a transceiver coupled to the at least one processor.

24. A method of wireless communication at a reduced bandwidth wireless device, comprising:
reserving one or more sidelink resources for a sidelink transmission, the one or more sidelink resources being associated with one or more subchannels in one or more slots; and
transmitting a sidelink resource reservation reserving the one or more sidelink resources, the sidelink resource reservation including an indication that the sidelink resource reservation is associated with the reduced bandwidth wireless device.

25. The method of claim 24, wherein transmitting the sidelink resource reservation further comprises signaling the sidelink resource reservation or broadcasting the sidelink resource reservation.

26. The method of claim 24, wherein the indication is associated with sidelink control information (SCI), and wherein the indication is transmitted via a physical sidelink control channel (PSCCH), a first stage SCI, a second stage SCI, or a medium access control (MAC) control element (CE).

27. The method of claim 24, wherein the one or more subchannels in the one or more slots is associated with a resource pool.

28. The method of claim 27, wherein the resource pool is associated with one or more wireless devices with a reduced bandwidth including the wireless device, the resource pool not being shared with one or more non-reduced bandwidth wireless devices.

29. A method of wireless communication at a non-reduced bandwidth wireless device, comprising:
receiving a sidelink resource reservation associated with an indication that the sidelink resource reservation is associated with a reduced bandwidth wireless device, the sidelink resource reservation reserving a set of resources for a sidelink transmission from the reduced bandwidth wireless device; and
excluding the set of resources as candidate resources for selection based on the indication.

30. The method of claim 29, wherein a priority is assigned to the sidelink transmission from the reduced bandwidth wireless device.
